(19) United States
(12) Patent Application Publication
(10) Pub. No.: US 2023/0083437 A1
(43) Pub. Date: Mar. 16, 2023

(54) HYPERDIMENSIONAL LEARNING USING VARIATIONAL AUTOENCODER

(71) Applicant: The Regents of the University of California, Oakland, CA (US)

(72) Inventor: Mohsen Imani, Irvine, CA (US)

(21) Appl. No.: 17/895,173

(22) Filed: Aug. 25, 2022

Related U.S. Application Data
(60) Provisional application No. 63/237,648, filed on Aug. 27, 2021.

(51) Int. Cl. G06N 3/08

(52) U.S. Cl. CPC G06N 3/088

(57) ABSTRACT

A hyperdimensional learning framework is disclosed with a variational encoder (VAE) module that is configured to generate variational autoencoding and to generate an unsupervised network that receives a data input and learns to predict the same data in an output layer. A hyperdimensional computing (HDC) learning module is coupled to the unsupervised network through a data bus, wherein the HDC learning module is configured to receive data from the VAE module and update an HDC model of the HDC learning module. The disclosed hyperdimensional learning framework provides a foundation for a new class of variational autoencoder that ensures that latent space has an ideal representation for hyperdimensional learning. Further disclosed is a hyperdimensional classification that directly operates over encoded data and enables robust single-pass and iterative learning while defining a first formal loss function and training method for HDC.

### RELATED APPLICATIONS

This application claims the benefit of provisional patent application Ser. No. 63/237,648, filed Aug. 27, 2021, the disclosure of which is hereby incorporated herein by reference in its entirety.

### GOVERNMENT SUPPORT

This invention was made with government funds under grant number N000142112225 awarded by the Department of the Navy, Office of Naval Research. The U.S. Government has rights in this invention.

### FIELD OF THE DISCLOSURE

The present disclosure relates to artificial neural networks and in particular to hyperdimensional computing that is adaptive to changes in environment, data complexity, and data uncertainty.

### BACKGROUND

Hyperdimensional computing (HDC) has been introduced as a computational model mimicking brain properties towards robust and efficient cognitive learning. The main component of HDC is an encoder that transforms data into knowledge that can be learned and processed at very low cost. Inspired by the human brain, the encoder maps data points into a high-dimensional holographic neural representation. Although the quality of HDC learning directly depends on the encoding module, the lack of flexibility and reliability arising from the deterministic nature of HDC encoding often significantly affects the quality and reliability of the hyperdimensional learning models. Therefore, a need remains for an HDC encoder that provides flexibility and reliability for hyperdimensional computing that is adaptive to changes in environment, data complexity, and data uncertainty.

### SUMMARY

A hyperdimensional learning framework is disclosed with a variational encoder (VAE) module that is configured to generate variational autoencoding and to generate an unsupervised network that receives a data input and learns to predict the same data in an output layer. A hyperdimensional computing (HDC) learning module is coupled to the unsupervised network through a data bus, wherein the HDC learning module is configured to receive data from the VAE module and update an HDC model of the HDC learning module.

The disclosed hyperdimensional learning framework provides a foundation for a new class of variational autoencoder that ensures that latent space has an ideal representation for hyperdimensional learning. Disclosed embodiments adaptively learn a better HDC representation depending on the changes in the environment, the complexity of the data, and uncertainty in data. Further disclosed is a hyperdimensional classification that directly operates over encoded data and enables robust single-pass and iterative learning while defining a first formal loss function and training method for HDC. Evaluation over large-scale data shows that the disclosed embodiments not only achieve faster and higher quality of learning but also provide inherent robustness to deal with dynamic and uncertain data.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a diagram showing a hyperdimensional classification.

FIGS. 2A and 2B are diagrams showing a naive and an adaptive hyperdimensional computing (HDC) model update, respectively.

FIG. 3 illustrates (a) a diagram showing an overview of variational autoencoder (VAE) training associated with the AutoHD encoder; and (b) a diagram showing an HDC framework exploiting VAE for adaptive hyperdimensional learning.

FIG. 4 is a diagram showing the impact of VAE prior (β) on classification accuracy of the AutoHD encoder.

FIG. 5 is a diagram showing the accuracy of the AutoHD encoder using different loss functions.

FIGS. 6A and 6B are diagrams showing the accuracy of the AutoHD encoder compared with existing machine learning methods and with state-of-the-art HDC methods, respectively.

FIGS. 7A to 7E are diagrams showing the impact of dimensionality on the classification accuracy of the AutoHD encoder.

FIG. 8 is a diagram showing the impact of VAE depth on the classification accuracy of the AutoHD encoder.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

The need for efficient processing for diverse cognitive tasks using a vast volume of data generated in Internet of Things (IoT) is increasing. Particularly, there is a crucial need for scalable methods for learning on embedded or edge devices. However, there are technical challenges making it difficult to process data on these devices. One technical challenge is computation efficiency. For example, running machine learning or data processing algorithms often results in extremely slow processing speed and high energy consumption. Yet other machine learning or data processing algorithms require a large cluster of application-specific integrated chips, such as deep learning on Google tensor processing units. Another technical challenge is a lack of robustness to noise. For example, edge devices often rely on unreliable power sources and noisy wireless communications. As such, modern machine learning systems have almost no robustness to such noise and typically fail due to lack of robustness.

Nevertheless, hyperdimensional computing (HDC) has shown great potential to outperform deep learning solutions in terms of energy efficiency and robustness, while ensuring a better or comparable quality of learning. Hyperdimensional computing is introduced as an alternative computational model that mimics important brain functionalities towards high-efficiency and noise-tolerant computation. Hyperdimensional computing is motivated by the observation that the human brain operates on high-dimensional data representations. In HDC, objects are thereby encoded with high-dimensional vectors, called hypervectors, which have thousands of elements. HDC incorporates learning capability along with typical memory functions of storing/loading information, and HDC mimics several important functionalities of the human memory model with vector operations that are computationally tractable and mathematically rigorous in describing human cognition.

HDC shows several advantages compared with the conventional deep learning solutions for learning in IoT systems. One advantage is that HDC is suitable for on-device learning based on hardware acceleration due to HDC's highly parallel nature. Another advantage is that hidden features of information can be well-exposed, thereby empowering both training and inference with the light-weight computation and a small number of iterations. Yet another advantage is that the hypervector representation inherently exhibits strong robustness against the noise and corrupted data. As a result, HDC may be employable as a part of many applications, including activity and gesture recognition, genomics, signal processing, robotics, and sensor fusion. Other advantages of HDC allow learning with a single iteration or very few iterations and learning with few samples while having inherent robustness to noise in hardware.

Regardless of the HDC functionality, transforming data into high-dimensional representation by encoding is a first step that uses randomly generated hypervectors. The quality of HDC learning depends on the encoding module. Many IoT systems deal with dynamic and uncertain data, mostly observed through imperfect data acquired from sensors. However, the lack of flexibility and reliability arising from the deterministic nature of the existing HDC encoding often substantially affects the quality and reliability of the model. Particularly, all previous HDC encoding methods are static and unreliable and thus cannot deal with the dynamic and uncertain data that exist in most real-world problems.

### Hyperdimensional Computing

### Hyperdimensional Learning

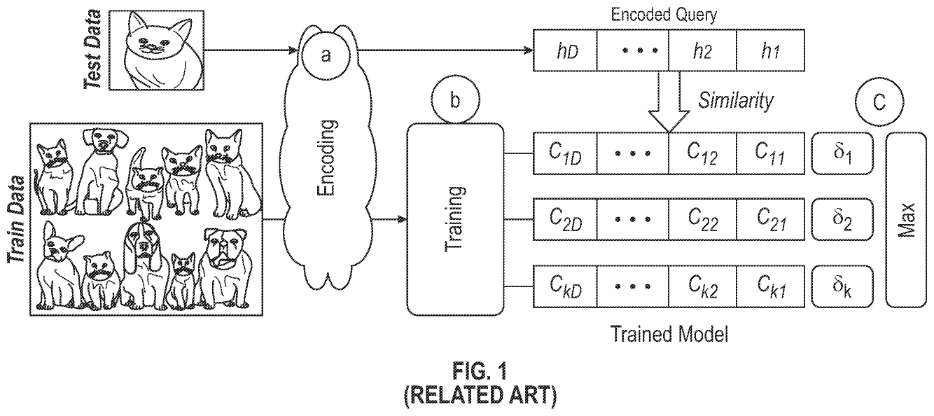

Hyperdimensional computing is a neurally inspired model of computation based on the observation that the human brain operates on high-dimensional and distributed representations of data. The fundamental units of computation in HDC are high-dimensional data or hypervectors, which are constructed from raw signals using an encoding procedure (FIG. 1 at a). During training, HDC superimposes together the encodings of signal values to create a composite representation of a phenomenon or interest known as a class hypervector (FIG. 1 at b). In inference, the nearest neighbor search identifies an appropriate class for the encoded query hypervector (FIG. 1 at c). Hyperdimensional computing can transform data into knowledge at very low cost and with better accuracy than state-of-the-art methods or comparable accuracy to state-of-the-art methods for diverse applications, such as classification, signal processing, and robotics.

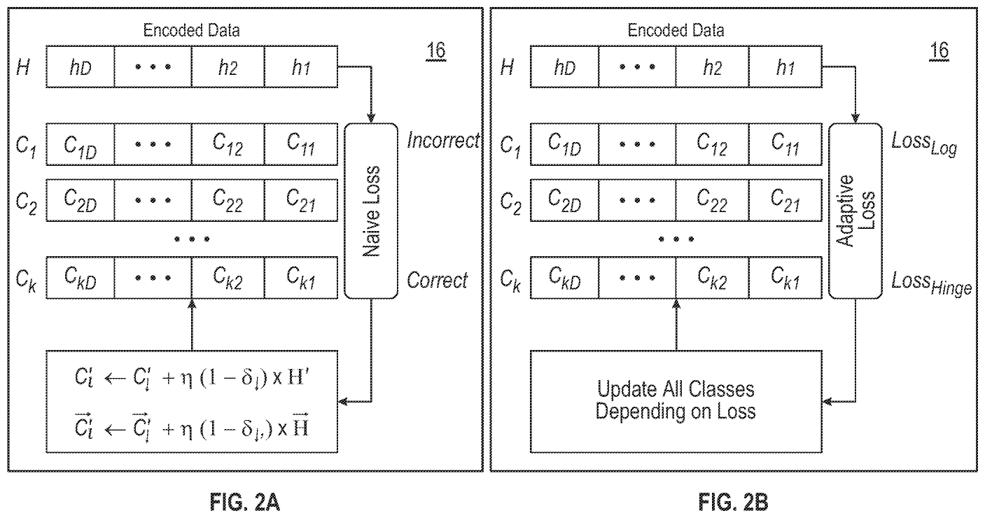

A first step in HDC is to map each data point into high-dimensional space. The mapping procedure is often referred to as encoding, as shown in FIGS. 2A and 2B. Hyperdimensional computing uses different encoding methods depending on data types. The encoded data should satisfy the common-sense principle that data points different from each other in the original space should also be different in the HDC space. For example, if a data point is entirely different from another, the corresponding hypervectors should be orthogonal in the HDC space. Assume an input vector, such as an image or voice, in original space \vec{F}={f₁, f₂, . . . , fₙ} and F ∈ [symbol] ⁿ. The encoding module maps this vector into a high-dimensional vector, H ∈ {−1, +1 [symbol] :D»n. Three common methods for HDC encoding are the following:
Associate-based Encoder: [symbol] =Σₖ₌₁ⁿ [symbol] ᵥₖ. [symbol] ₖ, where the k^{th} feature of the input is associated with a position hypervector ( [symbol] ₖ) with a feature value hypervector, [symbol] ₖ. Position hypervectors ( [symbol] ₖ) are randomly chosen to be a unique signature for each feature position. Thus, the position hypervectors are nearly orthogonal: δ( [symbol] ᵢ, [symbol] ⱼ)≅0 (i≠j), where δ denotes the cosine similarity. To maintain the closeness in feature values, the feature values are quantized into q levels. Then [symbol] ₁ and [symbol] _{q} are entirely random to represent minimum and maximum feature values. Each [symbol] ₖ₊₁ is obtained by mapping randomly chosen

$$\frac{𝒟}{2 \cdot q}$$

bits of [symbol] ₖ.
Permutation-based Encoder: [symbol] =Σₖ₌₁ⁿρ^{k} [symbol] ₖ₋₁, where ρ is a permutation. Permutation operation, ρⁿ( [symbol] ), shuffles components of [symbol] with n-bit(s) of rotation. The intriguing property of the permutation is that it creates a near-orthogonal and reversible hypervector [symbol] , that is, δ(ρⁿ( [symbol] ), [symbol] )≅0 when n≠0 and ρ⁻ⁿ(ρⁿ( [symbol] ))= [symbol] . Thus, the permutation operation is used to represent sequences and orders. Note that to maintain the closeness in feature values, the same feature value quantization is used as in the associate-based encoding.
Random Projection Encoder: [symbol] =Σₖ₌₁ⁿf_{k∈F}. [symbol] ₖ associates the scalar feature value with position hypervectors. Similar to an inclusive encoder, [symbol] ₖs are randomly chosen and hence are orthogonal bipolar base hypervectors that retain the spatial or temporal location or features in an input. That is, [symbol] ₖ ∈ {−1, +1 [symbol] and δ( [symbol] ᵢ, [symbol] ⱼ)≅0 (i≠j).

The foregoing encoding methods provide a different quality of learning and computational complexity. The inclusive encoder is the fastest encoder because the inclusive encoder predominately uses bitwise operations. The random projection encoder is the second low cost encoder, for the projection matrix is still a binary/bipolar matrix. In a non-linear encoder, both bases and feature values are non-binary, thus the random projection encoder incurs a slightly higher computational cost. However, in terms of quality of learning, the non-linear encoder is considered state-of-the-art with exceptional capability to extract knowledge from data.

### HDC Encoding Challenges

Despite the strengths, all existing HDC encoders are static and unreliable and thus cannot deal with the dynamic and uncertain data that exist in most real-world systems. In IoT systems, the environment and data points are dynamically changing. For example, as one moves through winter, spring, summer, and autumn, outdoor images that include foliage have different backgrounds and temperature sensors are collecting different ranges of values. Beside these seasonal changes in IoT systems, data points may get unpredictable changes, generating various unseen or variational data. Machine learning algorithms, including HDC, require labeled data to train a suitable model to adapt to a new environment. However, it is impractical and often infeasible to collect labels for data observed during inference.

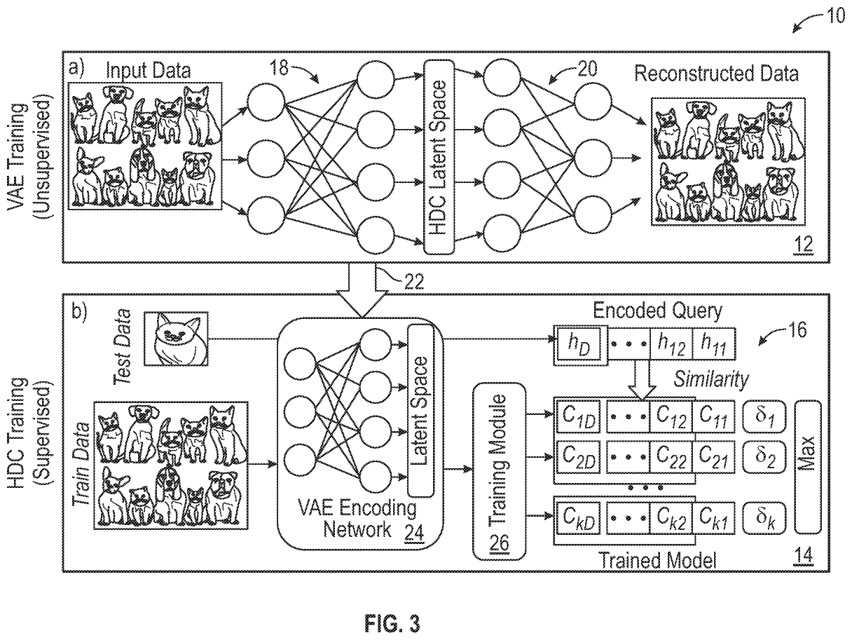

An ideal encoder for HDC should be able to find a better representation given new unlabeled data. FIG. 3 is a diagram disclosing a hyperdimensional learning framework with a self-trainable encoder referred to herein as an AutoHD encoder 10 that is structured in accordance with the present disclosure. The disclosed AutoHD encoder 10 makes use of variational autoencoding (VAE) to realize an unsupervised encoder that can dynamically adjust itself to changes in data and environment:
The AutoHD encoder 10 is unique compared to traditional HD encoders in that the disclosed AutoHD encoder 10 is an unsupervised trainable hyperdimensional encoding module that dynamically adjusts the similarity of the objects in high-dimensional space. The AutoHD encoder 10 provides a new class of VAE that ensures that the latent space has an ideal representation for hyperdimensional learning. The AutoHD encoder 10 adaptively learns a better HDC representation depending on the changes on the environment, the complexity of the data, and uncertainty in data.
Disclosed is a hyperdimensional classification that directly operates over encoded data and enables robust single-pass and iterative learning. The AutoHD encoder 10 defines a first formal loss function and training method for HDC that enables learning a highly accurate model with fewer iterations than traditionally needed. This enables coupling an HDC classification framework with multiple-layered neural networks using existing software such as PyTorch or TensorFlow.

The AutoHD encoder 10 was evaluated on a wide range of learning and cognitive problems. The results show that the AutoHD encoder 10 not only achieves faster and higher quality of learning but also provides inherent robustness to deal with dynamic and uncertain data. Over a traditional non-noisy data set, the AutoHD encoder 10 achieves, on average, 7.7% higher quality of learning compared with state-of-the-art HDC learning methods.

The AutoHD encoder 10 is a uniquely trainable variational encoder for HDC that is configured to dynamically change representation to adapt to changes in data. The AutoHD encoder 10 has a VAE module 12 and a hyperdimensional computing (HDC) learning module 14. Instead of using a static HDC encoder to map data into high-dimensional space as do traditional HDC encoders, the AutoHD encoder 10 employs the VAE module 12 in combination with a dynamic high-dimensional representation. The disclosed VAE module 12 is configured to generate variational autoencoding and generates an unsupervised network that receives a data input and learns to predict the same data in an output layer. During operation, the AutoHD encoder 10 fills VAE latent space with a relatively rich representation that considers the correlation of all inputted data. Traditionally, VAE latent space learns a low-dimensional representation of data. In contrast, the approach according to the present disclosure makes a unique modification to the unsupervised network of the VAE module 12 to learn a high-dimensional representation that can be directly used by an HDC model 16.

Learning in the AutoHD encoder 10 proceeds in two phases:
(1) Training the VAE module 12 in fully unsupervised manner to learn a suitable hyperdimensional representation (FIG. 3 at a). This training can happen offline since training does not rely on any labeled data.
(2) Utilizing the modified VAE module 12 as an HDC encoding module and accordingly training the HDC model 16 of the HDC learning module 14 (FIG. 3 at b). For all future predictions or training, the modified VAE module 12 can stay static while the HDC model 16 is updating.
(3) In case of changes on data trend or environment, the AutoHD encoder 10 has an option of updating the VAE module 12 over new unlabeled data. This gives a unique ability to the AutoHD encoder 10 to update the latent space representation to adapt to new data.
   This unique ability makes the AutoHD encoder 10 a relatively powerful tool to deal with dynamic data existing in real IoT systems.

### AutoHD Encoder: Variational Encoding

Variational autoencoding is a form of unsupervised learning in which a compact latent space of a data set is learned. In particular, autoencoding focuses on the training of the encoder that maps data to the latent space and the decoder that does the opposite. Variational autoencoding learns a distribution of the latent variables such that a sampling in the distribution is decoded into an item that resembles the training data. Conventionally, the distribution of the latent variables is in a low-dimensional space and has a Gaussian distribution. The present disclosure relates to a solution that uses VAE latent space to generate a holographic representation for hyperdimensional learning. Variational autoencoding can dynamically capture the correlative distance of data points in latent space depending on the data complexity. In addition, VAE is fully unsupervised with no training cost.

The VAE module 12 assumes that input data x comes from an unknown distribution p*(x) and seeks to approximate such a distribution with a generative neural network with parameters θ that defines a distribution p_{θ}(x)≈p*(x). Another assumption is that data has latent variables z and p_{θ}(x)≈∫p_{θ}(x, z) dz. Using traditional variational Bayes methods to optimize θ is not ideal since the intractable posterior p_{θ}(z|x) needs to be approximated. Additional parameters are introduced: ϕ of an encoder neural network 18 to define the distribution q_{ϕ}(z|x) such that q_{ϕ}(z)≈p_{θ}(z|x). This framework allows optimization of θ and ϕ simultaneously.

### VAE Representation

To train the VAE module 12, the maximization function is defined as the variational lower bound:

[symbol]

(θ, ϕ; x)=log p_{θ}(x)−D_{KL}(q_{ϕ}(z|x)∥p_{θ}(z|x))

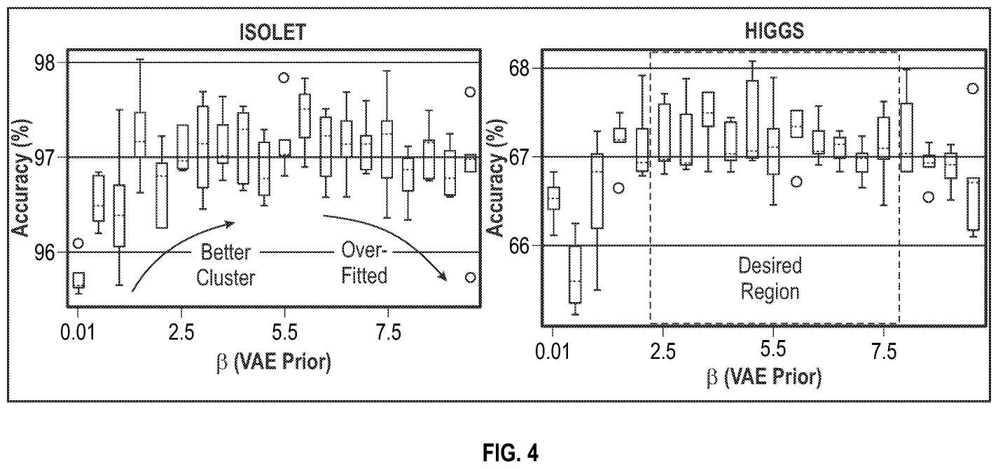

The maximizing function ensures that the parameters θ of the generative model p_{θ}(x) are the most likely, given the data. At the same time, the KL-divergence draws the approximate posterior q_{ϕ}(z|x) closer to the true intractable distribution p_{θ}(z|x). This maximization objective can be rewritten as follows:

$$ℒ ( θ , ϕ ; x ) = {\underbrace{{𝔼}_{z ∼ {q}_{ϕ} ( \cdot \vert x )} [ log {p}_{θ} ( x \vert z ) ]}}_{Negative Reconstruction Error} - {\underbrace{{D}_{K L} ( {q}_{ϕ} ( z \vert x ) ‖ {p}_{θ} ( z ) )}}_{Prior Regularization} ,$$

where the first term indicates the error between the input and the reconstructed data, and the second term of loss function is related to the closeness of latent space to the VAE prior (β). This term gets a higher value when the approximate posterior distribution is similar to the subjective prior. Previous work has modified this optimization objective by adding a hyperparameter β>0 to adjust the importance of each term. This model is known as β-VAE, as shown in FIG. 4:

[symbol]

(θ, ϕ; x)= [symbol] _{z˜q}_{_{ϕ}}_{(·|x)}[log p_{θ}(x|z)]−βD_{KL}(q_{ϕ}(z|x)∥p_{θ}(z))

Depending on the distribution of the original data, the negative reconstruction error takes different forms. For example, if input data come from multivariate independent Bernoulli distributions, x˜Bernoulli(p), then the negative reconstruction error yields the cross-entropy loss function

log p_{θ}(x|z)=Σᵢ₌₁^{M} oᵢ log xᵢ+(1−oᵢ) log(1−xᵢ),

where o=(oᵢ)ᵢ₌₁^{M} is the output of the VAE. In case of x˜ [symbol] (0, I), then log p_{θ}(x)=−∥x−o∥₂²+C.

VAE Hyperdimensional Representation: In HDC, hypervectors are holographic and (pseudo)random with independent and identically distributed components. A hypervector contains all the information combined and spread across all its components in a full holistic representation so that no component is more responsible for storing any piece of information than another. To ensure that the VAE generates HDC data, it must be shown that the latent space distribution holds independent and holographic representation. In particular, the latent space of the VAE q_{ϕ}(z|x) is parametrized with a fixed distribution by design. This distribution is often a multivariate normal distribution [symbol] (μ, σI) with prior q_{ϕ}(z) being [symbol] (0, I). This distribution is useful for HDC because, by design, the latent space is drawn from normal distributions, and the spaces are independent of one another.

To ensure holographic representation, neurons in the latent space should correspond to all input features. However, VAEs tend to have non-holographic representation as the dimensionality of latent space is growing. To eliminate that, the dropout layer right before a decoder neural network 20 (see FIG. 3) in the VAE module 12 is exploited. This layer changes the behavior randomly during training, zeroing some dimensions in the latent space. This addition makes the VAE module 12 generate a holographic distribution of data, which is a common property that HDC systems assume of input data.

### Hyperdimensional Classification

FIGS. 2A and 2B show an overview of processing steps the AutoHD encoder 10 takes during classification. The AutoHD encoder 10 is configured to use a pre-trained VAE as a hyperdimensional mapper to generate high-dimensional data. During the encoding, the AutoHD encoder 10 invokes the VAE encoder module 12 to generate the latent space while the decoding part can be neglected. High-dimensional data generated by latent space can be transferred over a data bus 22 to a VAE encoding network 24 and directly used for HDC learning (see FIG. 3). To find a universal property for each class in the training data set, a training module 26 (see FIG. 3) linearly combines hypervectors belonging to each class, that is, adding the hypervectors to create a single hypervector for each class. Once all hypervectors are combined, the per-class accumulated hypervectors, called class hypervectors, are treated as the learned model. FIG. 2 at a shows HDC functionality during training. Assuming a problem with k classes, the model represents using M={\vec{C}₁, \vec{C}₂, . . . , \vec{C}ₖ}. The AutoHD encoder 10 is configured to support different learning processes, as explained subsequently. After creating the model, the inference task is performed by checking the similarity of a query datum with class hypervectors. Each datum is assigned to a class that has the highest similarity.

### Hyperdimensional Training

Existing HDC learning methods first generate all encoding hypervectors belonging to a class/label l and then compute the class hypervector \vec{C}₁ by bundling (adding) all [symbol] ^{l}s, assuming there are [symbol] inputs having label l: \vec{C}ₗ= [symbol] [symbol] ⱼ^{l}.

Observe that the existing single-pass training methods saturate the class hypervectors in an HDC model. In a naive single-pass model, the encoded data that are more dominant saturate class hypervectors. Therefore, less common training data on the model have a lower chance to represent themselves. One solution to address this issue is to go iteratively over training data and to adjust the class hypervectors. The model adjustment increases the weight of input data that are likely to be misclassified with the current HDC model 16.

Iterative Training: Assume [symbol] as a new training data point. The AutoHD encoder 10 is configured to compute the cosine similarity of [symbol] with a class hypervector that has the same label as [symbol] . If the data point corresponds to the l^{th} class, the similarity of a data point is computed with \vec{C}ₗ as, δ( [symbol] , \vec{C}ₗ), where δ denotes the cosine similarity. Instead of naively adding data points to the model, the HDC learning module 14 is configured to update the HDC model 16 based on the δ similarity. For example, if an input data has label l, the HDC model 16 updates as follows:

\vec{C}ₗ←\vec{C}ₗ+η(1−δₗ)×

[symbol]

\vec{C}_{l′}←\vec{C}_{l′}+η(1−δ_{l′})×

[symbol]

where η is a learning rate. A large δ₁ indicates that the input is a common data point that already exists in the model. Therefore, the update adds a very small portion of encoded query to the model to eliminate model saturation (1−δ₁≅0).

### Adaptive Hyperdimensional Training

The explained HDC training methods are slow in convergence. This slowness comes from the HDC training process that only updates two class hypervectors for each misclassification. However, a mispredicted class hypervector may not be the only class against this prediction. In other words, with adjusting the pattern of a mispredicted class, other class hypervectors that may wrongly match with a query may also need to be adjusted. This increases the number of required iterations to update the HDC model 16. To create a clear margin between the class hypervectors, for the first time, a formal loss function is defined for the HDC model 16 that enables updating of all class hypervectors for each misprediction. For each sample of data during retraining, the formal loss function computes the chance that the data correspond to all classes. Then, based on a data label, the formal loss function adaptively updates all class hypervectors.

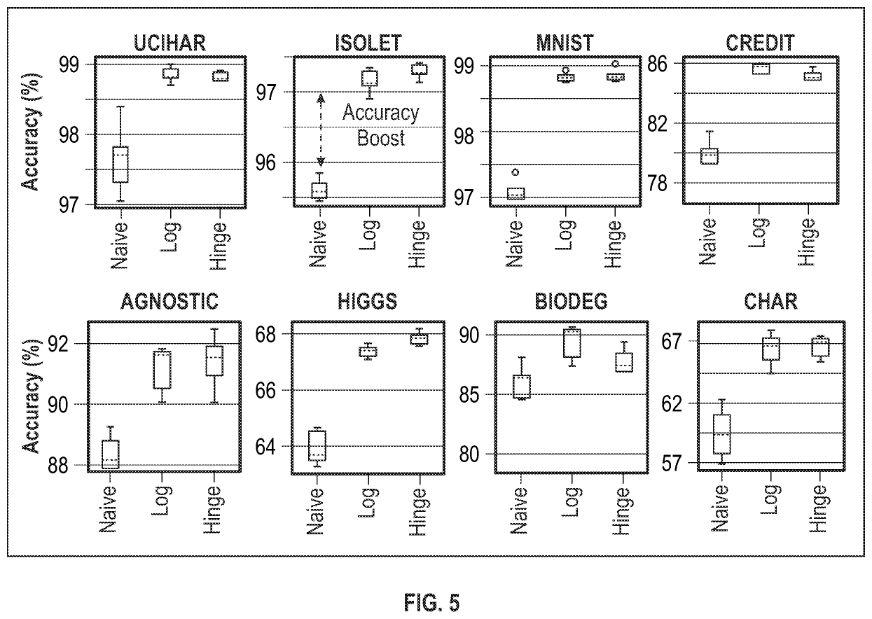

As FIG. 5 shows, the solution also updates the class hypervectors during correct prediction. In practice, there are differences between a marginal correct prediction and a high confidence prediction. The formal loss function updates the class hypervectors to ensure that a minimum number of iterations is needed to update the model. In addition, the trained hypervectors using this approach obtain higher margins. Previous work has used cosine similarity as a similarity metric. However, a decision function that is yielded by this method defines linear boundaries in the hyperdimensional space. Thus, it is easier to define the classification function utilizing only dot product, instead of cosine similarity, without harming the model expressiveness:

Argmaxᵢ₋₁^{k} [symbol] ·\vec{C}ᵢ

Using dot product introduces existing loss functions to the HDC learning module 14, and this comes with several benefits:
1. Defining an explicit loss function can help in evaluation of the current model performance with a precise meaning.
2. Continuous loss functions can be used that can be differentiated with respect to the hyperdimensional model parameters. This can help coupling HDC classification with ease in multiple-layered neural networks, using existing software such as PyTorch or TensorFlow.
3. As mentioned previously, current HDC classification algorithms update at most two classes at the same time. Using different loss functions can help in getting faster convergence, while keeping accurate predictions.

The present disclosure also focuses on two loss functions: hinge loss and logarithmic loss. The hinge loss is commonly observed in support vector machines. This function seeks to maintain all similarity predictions (dot product) of the correct class larger than a predefined value, commonly 1, compared with all the other classes. Thus, there are penalties not only on mispredictions but also on correct predictions with very low confidence scores. For this reason, this function is also known for maximum margin classification and yields robust linear classifiers.

$$hingeloss ( x ) = {\sum }_{i = 1 , i \neq y}^{k} max \{ 0 , 1 - {o}_{y} + {o}_{i} \}$$

where o=(oᵢ)ₖ₌₁^{k} is the similarity scores oᵢ= [symbol] ·\vec{C}ᵢ, and y is the true class label.

The logarithmic loss, also known as cross-entropy loss, transforms similarity scores to distributions and brings classification probabilities of the correct classes to 1, regardless of whether the samples are misclassified or not:

$$\begin{matrix}logloss ( x ) = - {\sum }_{i = 1}^{k} {p}_{i} ln {q}_{i} = - ln \frac{exp ( {o}_{y} )}{{\sum }_{{i}^{′} = 1}^{k} exp ( {o}_{{i}^{′}} )} & \end{matrix}$$

where pᵢ₋₁ if i=y, and zero otherwise, and q=(qᵢ)ᵢ₌₁^{k} is obtained using the softmax function in the outputs:

$${q}_{i} = \frac{exp ( {o}_{i} )}{{\sum }_{{i}^{′} = 1}^{k} exp ( {o}_{{i}^{′}} )}$$

The following show the impact of different loss functions on the accuracy and efficiency of the AutoHD encoder 10.

### Bayesian Optimization

Although the HDC model 16 can be used for online learning with a limited number of parameters, how one should select the best parameters is not clear. Disclosed is a Bayesian framework that identifies optimal hyperparameters of the AutoHD encoder 10 with limited sample data. The framework is used for at least two purposes: (1) finding the best hyperparameters for the AutoHD encoder 10 to maximize learning accuracy, which with the Bayesian framework can be performed using a very small number of samples; and (2) finding default parameters for the AutoHD encoder 10 to map into a new problem, which is necessary for problems for which not enough resources or time are available to optimize the AutoHD encoder 10 for each given data set.

### Evaluation

### Experimental Setup

An embodiment according to the present disclosure has been implemented with two co-designed modules, software implementation and hardware acceleration. In software, the effectiveness of the framework of the AutoHD encoder 10 was verified on large-scale learning problems. In hardware, training of the AutoHD encoder 10 and testing was implemented on central processing units (CPUs) and field-programmable gate arrays (FPGAs). For the FPGA, functional blocks of the AutoHD encoder 10 were created using Verilog and synthesized using the Xilinx Vivado Design Suite. The synthesis of the functional blocks was implemented on the Kintex-7 FPGA KC705 Evaluation Kit. Efficiency was ensured to be higher than another automated FPGA implementation. For the CPU, the code for the AutoHD encoder 10 was written in C++ and optimized for performance. The code has been implemented on Raspberry Pi (RPi) 3B+ using an ARM Cortex A53 CPU. The power consumption was collected by a Hioki 3337 power meter. Accuracy and efficiency of AutoHD encoder 10 were evaluated on several popular data sets (listed in Table 1) ranging from small data sets collected in a small IoT network to a large data set that includes hundreds of thousands of data points.

TABLE 1
Evaluated Data Sets

| Data Set | Task | Data Set | Task |
|---|---|---|---|
| UCIHAR | Human Activity | BIODEG | Biodegradable |
| | Recognition | | Classification |
| ISOLET | Voice | CHAR | Character |
| | Recognition | | Classification |
| MSNIST | Handwritten | EATING | Eating Prediction |
| | recognition | MASS | Mass-Spectrometry |
| CREDIT | Credit Risks | | Identification |
| | Classification | ADULT | Adult Income |
| AGNOSTIC | Identify Domain | | Prediction |
| | Knowledge | | |
| HIGGS | Higgs Bosons | | |
| | Recognition | | |

### Quality of Learning

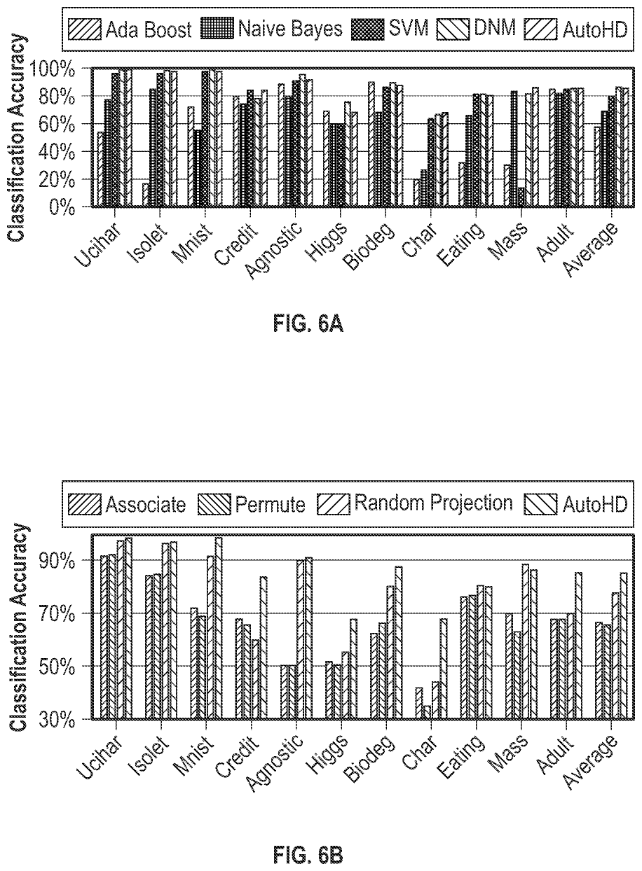

State-of-the-Art Machine Learning Algorithms: FIGS. 6A and 6B compare the accuracy of AutoHD learning with state-of-the-art machine learning algorithms, including adaptive boosting (AdaBoost), support vector machine (SVM), and deep neural network (DNN). The DNN models are trained with TensorFlow, and the Scikitlearn Library was exploited for the other algorithms. The common practice of the grid search was exploited to identify the best hyperparameters for each model. For the AutoHD encoder 10, D=4k was used as the dimensionality with a log-based loss function. The evaluation shows that the AutoHD encoder 10 provides very comparable accuracy to the existing learning algorithms: 6.1% and 16.7% higher than SVM and naïve Bayes, respectively, while only 0.3% lower than DNN.

Comparison with Existing HDC Algorithms: FIG. 6 also compares accuracy the AutoHD encoder 10 with state-of-the-art HDC-based encoding methods: (1) Associate-based Encoder, which represents feature values using hypervectors and associates them with random position hypervectors assigned to each feature position; (2) Permutation-based Encoder, which represents feature values using hypervectors and exploits permutation operations to preserve the order of features; and (3) Random Projection Encoder, which maps data into high-dimensional space after passing actual feature vectors through a projection matrix.

Evaluation shows that the AutoHD encoder 10 provides a significantly higher quality of learning compared with existing encoders. The AutoHD encoder 10 uses VAE to preserve the correlation of all data points in the latent space, which gives the HDC model 16 a higher capacity to store correlative data and learn a suitable functionality. The results indicate that the AutoHD encoder 10 provides, on average, 19.6%, 17.3%, and 7.7% higher classification accuracy compared with associate-based, permutation-based, and random projection encoders, respectively.

### Hyperdimensional Model Update

The quality of learning for the AutoHD encoder 10 was compared using three different methods:

Naïve Training, which updates the HDC model 16 for each misprediction. The update only affects two class hypervectors and does not consider how far or marginal the misprediction occurred.

Adaptive Training, which updates the HDC model 16 using two introduced loss functions: hinge and log. During adaptive training, all class hypervectors are updated, each misprediction as well as correct predictions. This method maximizes the margin between the class hypervectors during the training, ensuring higher quality of learning with a lower number of required iterations.

FIG. 5 shows the HDC quality of learning using different learning procedures, where the rectangle encloses that 50% of the data that are on that region and the dots show the outliers. All designs use the same VAE-based encoder. The evaluation shows that adaptive training improves the quality of learning and accelerates the model convergences compared with non-adaptive training methods. Using the introduced Hinge as loss functions, the quality of learning was further improved. The evaluation shows that the AutoHD encoder 10 using hinge and log loss functions achieves, on average, 5.2% and 5.3% higher quality of learning compared with the naive training method. In addition, hinge-based and log-based methods update the HDC model 16 for every data point during learning. This provides faster convergence and requires a lower number of iterations to converge to the desired model. The evaluation shows that hinge reduces the number of required iterations by 2.1× and 3.0× compared with non-adaptive training methods.

### VAE Configurations and HDC Learning

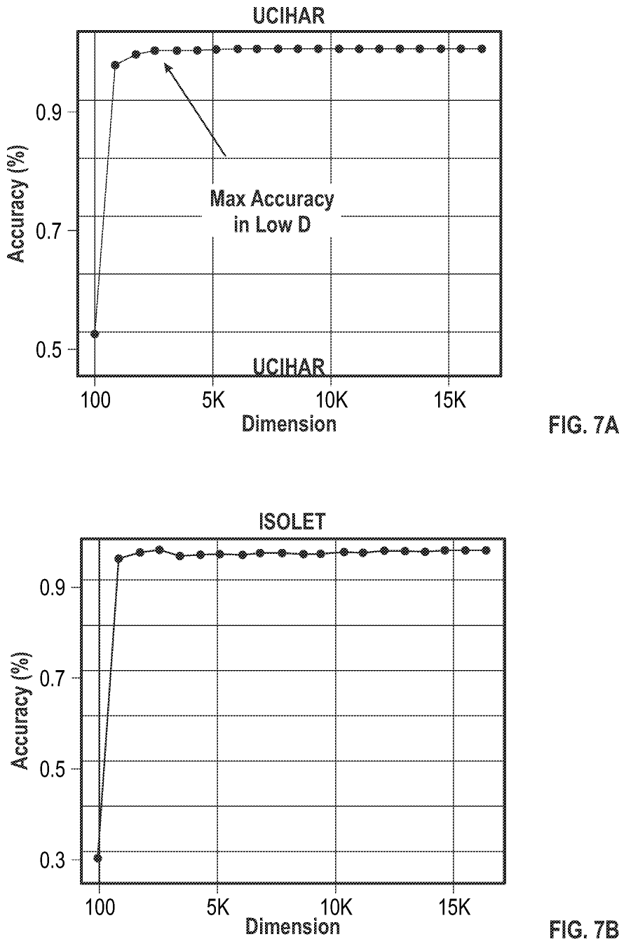

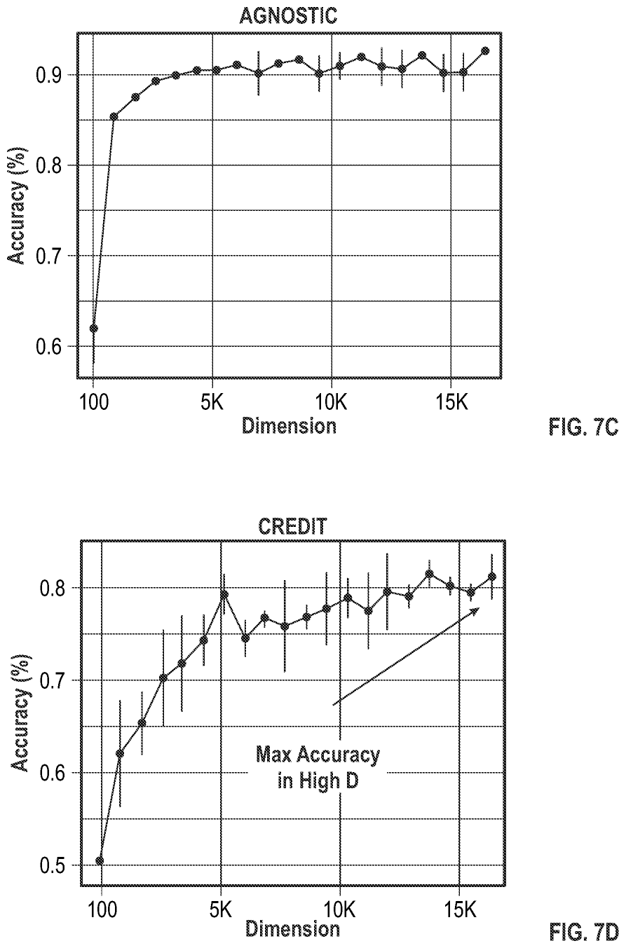

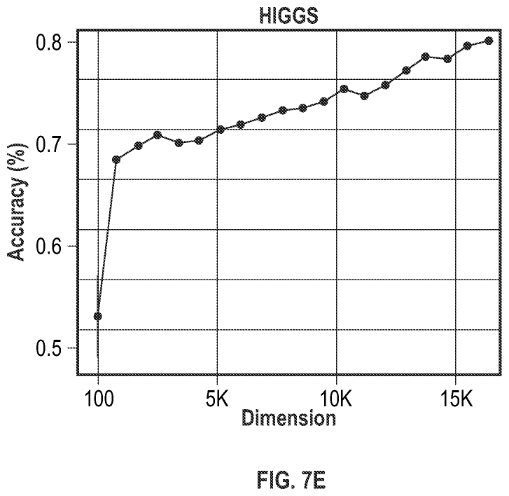

Dimensionality: FIG. 7 compares HDC quality of learning using hypervectors with different dimensions. The results are reported for the AutoHD encoder using a modified VAE-based encoder according to the present disclosure. The evaluation shows that the AutoHD encoder 10 provides higher quality of learning using higher dimensionality. The boost in accuracy comes from increasing the degree of freedom in latent space to separate data points in high-dimensional space. In other words, latent space can learn more complex representation that translates to higher quality of learning. For tasks with high complexity (e.g., HIGGs), increasing the dimensionality improves the classification accuracy. In contract, for less complicated data sets, accuracy is lost through saturation when dimensionality passes a certain value, for example, D=2k for UCIHAR.

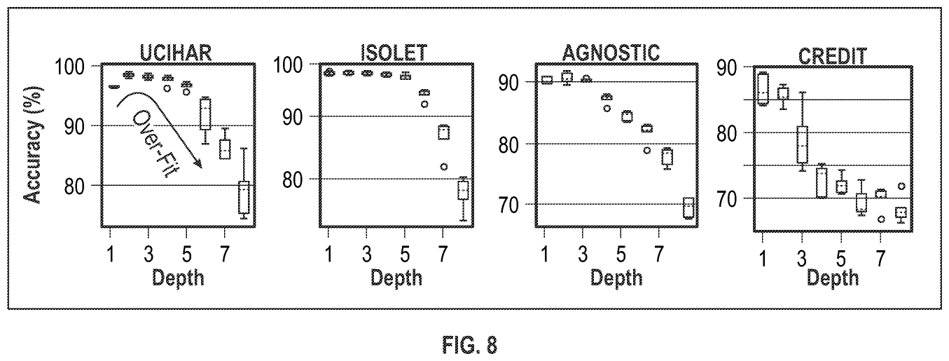

VAE Depth: The AutoHD encoder 10 uses VAE as an HDC encoding module. The quality or the VAE latent space has direct impact on learning accuracy of the AutoHD encoder 10. FIG. 8 shows the impact of a number of the VAE layers on classification accuracy of the AutoHD encoder 10. The results show that VAE with a few number of layers is enough to ensure maximum accuracy. Further increasing the number of layers results in overfilling issues of latent space and degradation of quality of learning of the AutoHD encoder 10.

The present disclosure discloses the AutoHD encoder 10, which is a uniquely adaptive and trainable HDC encoding module that dynamically adjusts the similarity of the objects in high-dimensional space. The AutoHD encoder 10 develops a new class or variational autoencoder that ensures the latent space has an ideal representation for hyperdimensional learning. The AutoHD encoder 10 adaptively learns a better HDC representation depending on the changes on the environment, the complexity of the data, and uncertainty in the data. Also disclosed is a hyperdimensional classification that directly operates over encoded data and enables robust single-pass and iterative learning while defining the first formal loss function and training method for HDC. Evaluation shows that the AutoHD encoder 10 not only achieves faster and higher quality of learning but also provides inherent robustness to deal with dynamic and uncertain data.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. A hyperdimensional learning framework comprising:
a variational encoder (VAE) module configured to generate variational autoencoding and to generate an unsupervised network that receives a data input and learns to predict the same data in an output layer; and
a hyperdimensional computing (HDC) learning module coupled to the unsupervised network through a data bus, wherein the HDC module is configured to receive data from the VAE module and update an HDC model of the HDC learning module.

2. The hyperdimensional learning framework of claim 1 wherein the VAE module has an input configured to receive unlabeled data and the HDC learning model is configured to update the HDC model based on the unlabeled data.

3. The hyperdimensional learning framework of claim 2 wherein the unsupervised network is an encoder neural network and the output layer comprises a decoder neural network with latent space between the encoder neural network and the decoder neural network.

4. The hyperdimensional learning framework of claim 1 wherein the HDC learning module is further configured to update class hypervectors of the HDC model for mispredicted ones of the class hypervectors.

5. The hyperdimensional learning framework of claim 3 wherein the HDC learning module is configured with a loss function that adaptively updates the hypervectors based on a data label.

6. The hyperdimensional learning framework of claim 5 wherein the loss function is a hinge type loss function.

7. The hyperdimensional learning framework of claim 5 wherein the loss function is a logarithmic type loss function.

8. The hyperdimensional learning framework of claim 4 wherein the HDC learning module is configured to employ a loss function to minimize a number of iterations needed to update the class hypervectors of the HDC model.

9. The hyperdimensional learning framework of claim 1 wherein the VAE module is implemented in a field programmable gate array (FPGA).

10. The hyperdimensional learning framework of claim 9 wherein the HDC module is implemented in the FPGA.

11. The hyperdimensional learning framework of claim 1 wherein the VAE module is implemented within a central processing unit (CPU).

12. The hyperdimensional learning framework of claim 11 wherein the HDC module is implemented within the CPU.

13. The hyperdimensional learning framework of claim 1 wherein the HDC module is configured to instantiate a hyperdimensional classification that directly operates over data encoded by the VAE module.

14. The hyperdimensional learning framework of claim 13 wherein the hyperdimensional classification achieves single-pass learning.

15. The hyperdimensional learning framework of claim 13 wherein the hyperdimensional classification achieves iterative learning.

18. The hyperdimensional learning framework of claim 1 wherein the VAE module is configured to remain static while the HDC learning module updates the HDC model after a first prediction.

17. The hyperdimensional learning framework of claim 1 wherein the VAE module is configured to generate a holographic distribution of the data.

18. The hyperdimensional learning framework of claim 1 wherein the HDC learning module comprises a training module that is configured to linearly add hypervectors associated with a class into a single hypervector that represents the class as a class hypervector.

19. The hyperdimensional learning framework of claim 18 further configured to perform dot product between a new training data point with a class hypervector that has a same label as the new training data point.

20. The hyperdimensional learning framework of claim 19 wherein the HDC learning module is configured to update the HDC model based on the dot product.
